(19) United States
(12) Patent Application Publication
(10) Pub. No.: US 2005/0037318 A1
(43) Pub. Date: Feb. 17, 2005

(54) Locking-taper abutment for dental implants

(76) Inventor: Bum-Kyu Han, Seoul (KR)

Correspondence Address: DELIO & PETERSON, 121 WHITNEY AVENUE, NEW HAVEN, CT, 06510, US

(21) Appl. No.: 10/915,163

(22) Filed: Aug. 9, 2004

(30) Foreign Application Priority Data
Aug. 13, 2003 (KR) 26188/2003

(51) Int. Cl. A61C 8/00

(52) U.S. Cl. 433/173

(57) ABSTRACT

The present invention provides a locking-taper abutment which has a crown bonding layer having a good polishing workability and sufficient bonding ability that an artificial crown is firmly supported on the crown bonding layer. The locking-taper abutment includes a post part which is inserted into a well provided in the fixture while enlarging in diameter from bottom to top. The locking-taper abutment further includes a body part. The body part has a seating part extending upwards from the upper portion of the post part exposed to the outside of the well while a diameter of the seating part enlarges from a bottom to a top. The seating part is supported on an inner surface of a gingiva under a gingival crest. The body part further has a vertical part extending upwards from an upper surface of the seating part, with a stopper provided around an outer surface of the upper portion of the seating part. The locking-taper abutment further includes a crown bonding layer covering both the upper surface of the seating part and an outer surface of the vertical part. The locking-taper abutment makes it easy to execute a dental implant operation. Furthermore, The locking-taper abutment prevents an artificial crown bonding agent from flowing into the gingivae.

### BACKGROUND OF THE INVENTION

1. Field of the Invention

The present invention relates generally to abutments for dental implants to make artificial teeth, and more particularly, to a locking-taper abutment which is coupled at a lower end thereof to a fixture of an implant installed in alveolar bone, and has a crown bonding layer which covers an outer surface of an upper portion of the locking-taper abutment, exposed to the outside between inner and outer gingivae, and is made of a resin or acryl that is easily bonded to an artificial crown, so that the locking-taper abutment solves conventional operational difficulties in that, when an artificial crown is bonded and fastened to an outer surface of the abutment, the gingiva must be widened to insert a lower end of the artificial crown into the gingiva for preventing the outer surface of the abutment made of a metal from being exposed to the outside, and the locking-taper abutment prevents excessive bleeding of the gingiva and prevents a bonding agent for fastening the artificial crown to the locking-taper abutment from flowing into the gingiva.

2. Description of the Related Art

Humans have milk teeth which usually erupt in babyhood, and permanent teeth which replace the milk teeth. Once the permanent teeth are damaged by careless maintenance or accident, they are impossible to replace.

In Korean, healthy teeth have been considered as one of the Five Big Blessings. That is, it is very important to keep the permanent teeth in health from the earliest days. However, it is not unusual to lose the permanent teeth by unexpected accidents.

When the permanent teeth are lost, except the wisdom teeth which cause almost no inconvenience when missing, it is not only quite uncomfortable to take in foods but also poor in appearance. Therefore, almost all people missing permanent teeth use artificial teeth rather than live without permanent teeth. A dental implant operation, which is a representative example of a method of having artificial teeth put in, which has markedly developed recently, will be explained herein below.

The dental implant operation is a dental surgical operation, in which an artificial tooth root is installed in alveolar bone after a damaged tooth is completely removed from the alveolar bone and, thereafter, an artificial crown, which is modeled on an original permanent tooth, covers an outer surface of the artificial tooth root so as to serve as the permanent tooth. In this case, an implant is used for the artificial tooth root.

The implant must not interfere with regrowth of bone and must be integrated with the alveolar bone. Furthermore, an immunological rejection response must not be exhibited. In addition, the gingivae must be well attached to the implant. To achieve the above-mentioned purposes, the implant is typically made of titanium.

The implant having the above-mentioned specific characteristics includes a fixture to be installed in the alveolar bone, and an abutment which is coupled at a lower end thereof to the fixture and protrudes outwards from an upper portion of the gingiva to be exposed to the outside. FIGS. 1A through 1C are sectional views showing a representative example of conventional dental implant operations. As shown in FIGS. 1A through 1C, a fixture 10 with a well (W) opened upwards is installed in an alveolar bone 1. Thereafter, a conventional abutment 11 is inserted into the well (W) of the fixture 10. An artificial crown 12 thereafter covers an outer surface of the abutment 11 exposed to the outside.

The conventional abutment 11 includes a post part 11A which is coupled to the fixture 10, and a body part 11B which extends upwards from an upper portion of the post part 11A while being exposed outside a gingiva 2. The body part 11B includes a seating part 11B1 which is supported on the gingiva 2 while enlarging in diameter from the bottom to the top. The body part 11B further includes an exposed part 11B2 which is exposed outside the gingiva 2 while being reduced in diameter from the top to the bottom.

According to a method of coupling the abutments to the fixtures, the conventional implants are classified into two types, which are screw type implants, in which the post parts of the abutments are tightened into the wells of the fixtures through threaded engagement structures, and locking-taper type implants, in which the post parts of the abutments are forcibly inserted into the wells of the fixtures in the same manner as in a wedge coupling. However, the conventional implants have the following two significant problems.

First, in the conventional screw type implants, the abutments may be undesirably moved from the fixtures due to outside impacts and the threaded engagement structure. Furthermore, because fine gaps exist between the abutments and the fixtures, food remnants may be held in the fine gaps, which can become rotten and thereby cause halitosis, doing damage to neighborhood teeth.

In an effort to overcome the problems experienced in the screw type implants, the locking-taper type implants were proposed. The conventional locking-taper type implants are advantageous in that manufacturing accuracies of the implants are superior to that of thread machining required in the screw type implants. Furthermore, processes of manufacturing the locking-taper type implants are simple. Moreover, the locking-taper type implants simplify dental implant operations. However, in the locking-taper type implants, abutments do not have sufficient surface areas that are in contact with fixtures, thus reducing friction between the fixtures and the abutments. Therefore, the abutments may be undesirably removed from the fixtures due to impacts transferred from the outside.

In a detailed description, a rod-type post part of the abutment of each of the conventional locking-taper type implants has a circular cross-section and a tapered outer surface which is reduced in diameter from the top to the bottom. When the rod-type post part is inserted into a well of the fixture, compressed air is generated between a lower end of the rod-type post part and a bottom of the well. Accordingly, the compressed air acts as a force to push out the rod-type post part of the abutment outside the well of the fixture, thus weakening the coupling of the abutment to the fixture. Furthermore, because the post part of the abutment has a rod-shaped appearance, radial elastic force of the post part is weak. Thus, a contact force between the outer surface of the rod-type post part and an inner surface of the well is reduced. Therefore, the abutment may be removed from the fixture by even a small outside impact.

Second, in each conventional implant, the artificial crown, which is modeled on an original permanent tooth, covers the body part of the abutment. At this time, if the abutment, which is made of metal, is not completely covered by the gingiva, it is somewhat poor in appearance. Therefore, as shown in FIGS. 1A through 1C, the artificial crown 12 must cover the body part 11B of the abutment 11 to a position under a gingival crest 1 to prevent the abutment 11 from being exposed to the outside.

Furthermore, an outer layer (R), which includes an outer surface of the exposed part 11B2 and a portion of an outer surface of the seating part 11B1 of the body part 11B of the abutment 11 fastened to the fixture 11, is removed through a polishing process, before the artificial crown 12 covers the polished outer surface of the body part 11B. At this time, the gingiva 2, into which the abutment 11 is inserted, must be widened to place a lower end of the artificial crown 12 under the gingival crest (T).

Therefore, the gingivae 2 may bleed excessively while the artificial crown 12 covers the abutment 11. In addition, a bonding agent, which is applied to the polished outer surface of the body part 11B of the abutment 11 and the inner surface of the artificial crown 12, may undesirably flow into the gingivae 2 through gaps between the gingiva 2 and the abutment 11. Moreover, it is very difficult to remove the bonding agent drawn into the gingivae 2. Furthermore, the gingivae 2 may be damaged during a process of eliminating the bonding agent drawn into the gingivae 2. If some bonding agent remains in the gingivae 2, paradentitis may be induced. As such, there are the many difficulties in the dental implant operations using the conventional implants.

In a detailed description, the gingival crest (T), which is an upper end of the gingivae 2, is positioned around a boundary between the exposed part 11B2 and the seating part 11B1. To place a crown margin 12A, which is the lower end of the artificial crown 12, under the gingival crest (T), the outer layer (R), which includes the outer surface of the exposed part 11B2 and a portion of an outer surface of the seating part 11B1 of the body part 11B of the abutment 11, must be removed through the polishing process. Thereafter, the artificial crown 12 covers the polished body part 11B by an upper surface of the seating part 11B2, so as to prevent the abutment 11 from being exposed to the outside. As described above, because the artificial crown 12 must cover the abutment 11 without exposure of the abutment 11, there are the above-mentioned difficulties in the dental implant operations using conventional implants.

Furthermore, it is very difficult to polish the outer layer (R) of the body part 11B of the abutment 11, which is made of high-strength metal.

### SUMMARY OF THE INVENTION

Accordingly, the present invention has been made keeping in mind the above problems occurring in the prior art, and an object of the present invention is to provide a locking-taper abutment, which is not exposed to the outside, even though a gap exists between a crown margin of an artificial crown and a gingival crest, and in which an elastic force of a lower end of the locking-taper abutment is markedly increased, so that the locking-taper abutment is firmly fastened to a fixture due to the elastic force, and which is easily modified in appearance to simplify a process of manufacturing the artificial crown.

In order to accomplish the above object, the present invention provides a locking-taper abutment, including: a post part; a body part having a vertical part and a crown bonding layer covering the vertical part; and a conical elastic hole provided in a lower end of the post part.

The locking-taper abutment of the present invention is characterized in that the vertical part and the crown bonding layer covering the vertical part are provided to protrude outside a gingiva, in place of exposed parts of conventional abutments, and the post part includes at the lower end thereof the conical elastic hole having a ring-shaped cross-section, so that the post part has a sufficient elastic force to increase a contact force between the locking-taper abutment and a fixture.

The locking-taper abutment of the present invention has a structure in that the vertical part is reduced in size in comparison with the exposed parts of the conventional abutments, and the vertical part is covered with the crown bonding layer which is made of a material, such as a resin or acryl, which is harmless to the human body and has superior bonding ability. The vertical part extends upwards from an upper surface of a seating part which is placed under a gingival crest while the post part is inserted in the fixture installed in alveolar bone. A lower end of the crown bonding layer covering an outer surface of the vertical part is placed under the gingival crest while an upper portion of the crown bonding layer is exposed outside the gingivae. Thus, even though an artificial crown covers an outer surface of the crown bonding layer over the gingival crest, the locking-taper abutment made of the metal is not exposed to the outside due to the crown bonding layer.

When the crown bonding layer has a color which is the same as or similar to that of the artificial crown, even though a crown margin, which is the lower end of the artificial crown covering the locking-taper abutment, is placed over the gingival crest, a superior appearance is maintained because the crown bonding layer is exposed to the outside while preventing exposure of the locking-taper abutment to the outside.

Furthermore, the locking-taper abutment of the present invention has a conical elastic hole which is provided in the lower end of the post part. By the conical elastic hole, the elastic force of the lower end of the post part is increased. Simultaneously, the conical elastic hole increases a space, which is defined between the lower end of the post part and a bottom of a well of the fixture when the locking-taper abutment is coupled to the fixture, thus reducing the compressibility of the air in the space.

In other words, the lower end of the locking-taper abutment of the present invention has a ring-shaped cross-section due to the conical elastic hole, different from the conventional abutments having circular-shaped cross-sections. Therefore, the lower end of the post part has increased elastic force. Furthermore, the space defined between the post part and the fixture is increased. Thus, when the post part of the locking-taper abutment is inserted into the well of the fixture, the compressibility of the air in the space is reduced, thus reducing a force tending to push the locking-taper abutment outside the well of the fixture.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A through 1C are views showing a conventional implant, wherein:

FIG. 1A is an exploded sectional view of the conventional implant;

FIG. 1B is a sectional view showing a conventional dental implant operation, in which an artificial crown is separated from the implant; and

FIG. 1C is a sectional view showing the completed conventional dental implant operation, in which the artificial crown covers the implant;

FIGS. 2A and 2B are sectional views of a locking-taper abutment, according to an embodiment of the present invention, wherein:

FIG. 2A is an exploded sectional view of the locking-taper abutment; and

FIG. 2B is a sectional view of the locking-taper abutment; and

FIGS. 3A and 3B are views showing a dental implant operation using the locking-taper abutment of FIG. 2B, wherein:

FIG. 3A is a sectional view showing the locking-taper abutment inserted in an alveolar bone prior to being covered with an artificial crown; and

FIG. 3B is a sectional view showing the locking-taper abutment covered with the artificial crown while being inserted in the alveolar bone.

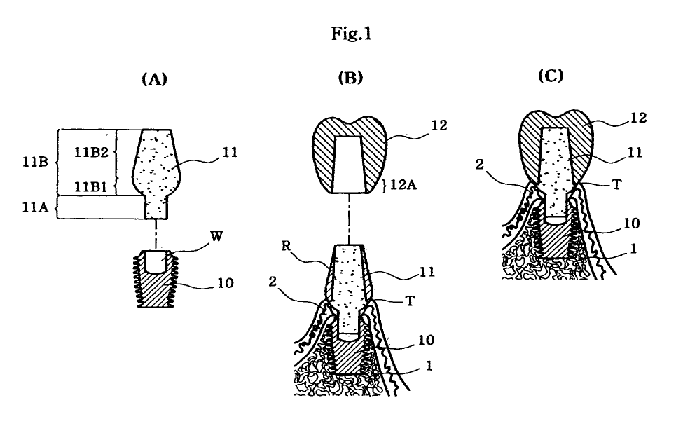

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

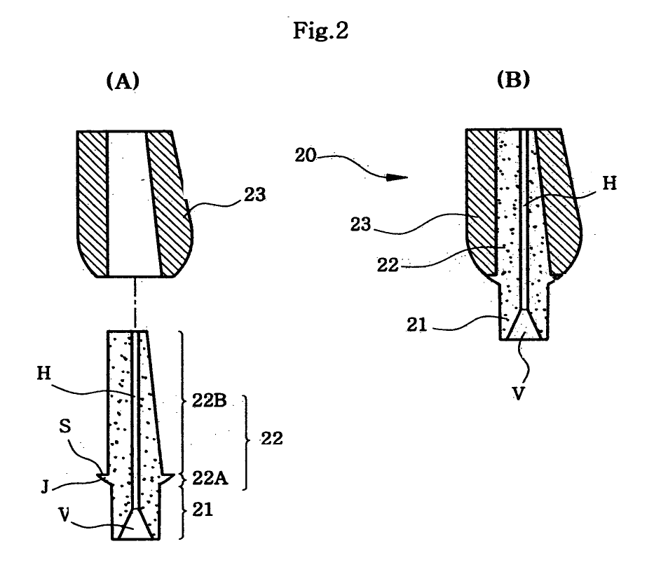

FIGS. 2A and 2B are sectional views of a locking-taper abutment 20, according to an embodiment of the present invention, wherein: FIG. 2A is an exploded sectional view of the locking-taper abutment 20; and FIG. 2B is a sectional view of the locking-taper abutment 20.

As shown in FIGS. 2A and 2B, the locking-taper abutment 20 of the present invention includes a post part 21 which is inserted into a well (W) provided in a fixture 10 while enlarging in diameter from the bottom to the top. A conical elastic hole (V) is provided in a lower end of the post part 21.

The locking-taper abutment 20 further includes a body part 22. The body part 22 has a seating part 22A which integrally extends upwards from the upper portion of the post part 21 while a diameter of the seating part 22A enlarges from the bottom to the top. The seating part 22A is supported on an inner surface of a gingiva 2 under a gingival crest (T). The body part 22 further has a vertical part 22B which integrally extends upwards from an upper surface (S) of the seating part 22A to provide a stopper (J) around an outer surface of the upper portion of the seating part 22A.

The locking-taper abutment 20 further includes a crown bonding layer 23 covering both the upper surface (S) of the seating part 22A and an outer surface of the vertical part 22B.

At this time, both the post part 21 and the body part 22 are made of titanium alloys. The crown bonding layer 23 is made of a material, such as a resin or acryl, which is harmless to the human body and is easily adapted for machining, such as polishing, and is easily attached to the surface of a support made of a metal. A dental implant operation using the locking-taper abutment of the present invention will be described herein below.

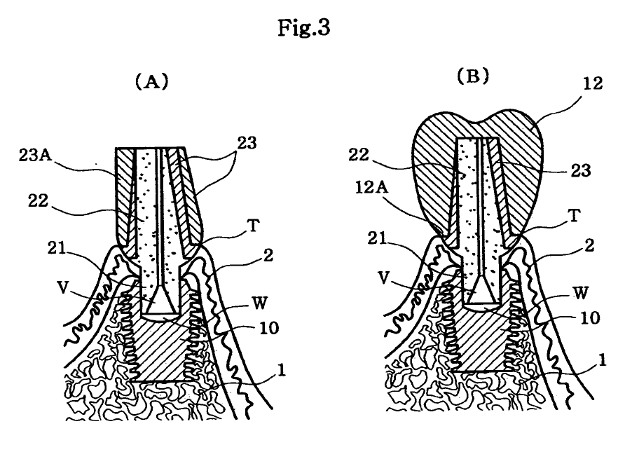

Referring to FIGS. 3A and 3B, the locking-taper abutment 20 of the present invention is inserted into the fixture 10 which is installed in alveolar bone 1. Thereafter, an outer layer 23A, which is a portion of the crown bonding layer 23 and is located above the gingival crest (T), is polished to a predetermined thickness. Thus, the outer layer 23A is removed from the crown bonding layer 23. An artificial crown 12 thereafter covers and is bonded to the polished outer surface of the crown bonding layer 23 to complete the dental implant operation. In the present invention, the body part 22 made of metal is not exposed to the outside due to the crown bonding layer 23. Therefore, it is unnecessary to insert a crown margin 12A of the artificial crown 12 under the gingiva 2 below the gingival crest (T). That is, the artificial crown 12 covers only an outer surface of a portion of the locking-taper abutment 20, which is placed right above the gingival crest (T).

In the locking-taper abutment 20 of the present invention having the above-mentioned structure, the conical elastic hole (V) is provided on the lower end of the post part 21. Therefore, the lower end of the post part 21 has a ring-shaped cross-section, thus being highly elastic. Due to the elasticity of the lower end of the post part 21, a contact force, applied to an outer surface of the post part 21 which is in close contact with an inner surface of the well (W) of the fixture 10, is increased. Furthermore, due to the conical elastic hole (V) provided in the lower end of the locking-taper abutment 20, the compressibility of the air in a space defined between the lower end of the locking-taper abutment 20 and a bottom of the well (W) is reduced in comparison with conventional abutments. Accordingly, a force tending to push out the locking-taper abutment 20 from the fixture 10 is also reduced in comparison with the conventional abutments. However, some force tending to push out the locking-taper abutment 20 from the fixture 10 still remains.

Preferably, to eliminate the above-mentioned force tending to push out the locking-taper abutment 20 from the fixture 10, the locking-taper abutment 20 of the present invention further includes an air discharging hole (H) which extends from an upper end of the conical elastic hole (V), provided in the lower end of the post part 21, to an upper end of the body part 22. Thus, when the post part 22 of the locking-taper abutment 20 is inserted into the well (W) of the fixture 10, air between the lower end of the locking-taper abutment 20 and a bottom of the well (W) is smoothly discharged to the outside through the air discharging hole (H).

At this time, in the case in which the air discharging hole (H) is provided in the lower end of the locking-taper abutment 20, the crown bonding layer 23 must not cover an upper end of the vertical part 22B. If it is difficult to machine the conical elastic hole (V) in the lower end of the post part 21, the air discharging hole (H) may extend from the upper end of the body part 22 to the lower end of the post part 21 without the conical elastic hole (V).

As described above, the present invention provides a locking-taper abutment which has a crown bonding layer that is made of a resin or acryl and covers an outer surface of an upper portion of the locking-taper abutment. Therefore, the locking-taper abutment does not require displacement of the gingivae to install an artificial crown, thus easing the dental implant operation, and preventing an agent for bonding the artificial crown to the locking-taper abutment from undesirably flowing into the gingivae.

Furthermore, the locking-taper abutment of the present invention further has a conical elastic hole which is provided in a lower end of the locking-taper abutment. The compressibility of the air in a space defined between a post part of the locking-taper abutment and a fixture is reduced. Therefore, a force tending to push out the locking-taper abutment from the fixture is reduced. In addition, due to the conical elastic hole, an elastic force of the post part is strengthened. Thus, the contact force between an outer surface of the post part and an inner surface of a well of the fixture is increased. Accordingly, the locking-taper abutment is stably fastened to the fixture.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A locking-taper abutment to be coupled to a fixture which is installed in alveolar bone, and comprising:
a post part to be inserted into a well provided in the fixture while enlarging in diameter from bottom to top and being exposed at an upper portion thereof to an outside of the well;
a body part, comprising:
a seating part extending upwards from the upper portion of the post part exposed to the outside of the well while a diameter of the seating part enlarges from bottom to top, the seating part being supported on an inner surface of a gingiva under a gingival crest; and
a vertical part extending upwards from an upper surface of the seating part, with a stopper provided around an outer surface of the upper portion of the seating part; and
a crown bonding layer covering both the upper surface of the seating part and an outer surface of the vertical part.

2. The locking-taper abutment according to claim 1, wherein the post part and the body part are made of titanium alloys.

3. The locking-taper abutment according to claim 1, wherein the crown bonding layer is made of a resin or acryl.

4. The locking-taper abutment according to claim 1, further comprising:
an air discharging hole extending from a lower end of the post part to an upper end of the body part.

5. A locking-taper abutment to be coupled to a fixture which is installed in alveolar bone, and comprising:
a post part to be inserted into a well provided in the fixture while enlarging in diameter from bottom to top and being exposed at an upper portion thereof to an outside of the well, with a conical elastic hole provided in a lower end of the post part;
a body part, comprising:
a seating part extending upwards from the upper portion of the post part exposed to the outside of the well while a diameter of the seating part enlarges from bottom to top, the seating part being supported on an inner surface of a gingiva under a gingival crest; and
a vertical part extending upwards from an upper surface of the seating part, with a stopper provided around an outer surface of the upper portion of the seating part; and
a crown bonding layer covering both the upper surface of the seating part and an outer surface of the vertical part.

6. The locking-taper abutment according to claim 5, wherein the post part and the body part are made of titanium alloys.

7. The locking-taper abutment according to claim 5, wherein the crown bonding layer is made of a resin or acryl.

8. The locking-taper abutment according to claim 5, further comprising:
an air discharging hole extending from an upper end of the conical elastic hole to an upper end of the body part.
